(19) United States
(12) Patent Application Publication
(10) Pub. No.: US 2019/0185114 A1
(43) Pub. Date: Jun. 20, 2019

(54) Bodyboard for use in aquatic environments with LED light rope, inductive charging capabilities, and molded channels.

(71) Applicant: Susan Voaklander, Cardiff, CA (US)

(72) Inventor: Susan Voaklander, Cardiff, CA (US)

(21) Appl. No.: 16/280,175

(22) Filed: Feb. 20, 2019

Related U.S. Application Data
(63) Continuation-in-part of application No. 15/362,414, filed on Nov. 28, 2016, now Pat. No. 10,253,969.

(51) Int. Cl. B63B 35/79; H02J 50/10; F21S 4/10; F21L 4/02; F21L 4/08; F21V 31/00; F21V 33/00; B63B 45/00

(52) U.S. Cl. CPC B63B 35/7933; H02J 50/10; F21S 4/10; F21L 4/02; F21Y 2115/10; F21V 31/005; F21V 33/0084; B63B 45/00; F21L 4/08

(57) ABSTRACT

This invention is directed toward a body board, used for enjoying aquatic environments, which has one of more strings of LED lights disposed in one or more channels that have been molded or routed into the top, bottom, or sides of the body board. The LED's are powered by a rechargeable battery pack disposed in a wireless charger cavity in the bodyboard, along with a wireless charging receiver and an LED controller, which is covered by a watertight bodyboard sealant cover to prevent water from damaging the electronic components. In particularly preferred embodiments, the bodyboard core is white beaded polypropylene foam and a P9242-R 15W wireless charging transmitter is used to charge a P9221-R 15W wireless charging receiver.

### CROSS REFERENCE TO RELATED APPLICATIONS

This application is a continuation-in-part and claims priority to U.S. Utility application Ser. No. 15/362,414 filed Nov. 28, 2016, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of bodyboards, and more specifically, to a bodyboard capable of being used in aquatic environments with channels that contain programmable LED light ropes. The power for the LED light ropes come from a rechargeable battery and wireless charger, which can be wirelessly charged through a wireless charging transmitter. An optional solar panel embedded in the deck of the bodyboard recharges a battery which powers the solar lights. The goal of the invention is to provide a lighted bodyboard for use in water parks and wave pools, where the lights form some sort of decorative pattern, but to be tough enough to withstand the rigors of children playing with the boards in an aquatic environment.

### BRIEF SUMMARY OF THE INVENTION

First, it should be noted that the phrases “body board” and “bodyboard” are interchangeable. The priority document referred to them as “body boards”, but over time, the trademarked phrase “Boogie Board®” has fallen into disfavor and has been replaced with “bodyboard”. The channels of the body board, or bodyboard, are covered by a removable, water-resistant covering that waterproofs the board such that the electrical components are not damaged or destroyed by the surrounding water. It is contemplated that the channels in the bodyboard can be on some combination of the sides, top and bottom of the board, and can be effectively waterproofed. The LED's are powered by a battery that rests in a cavity in the bodyboard, where the cavity is also covered by a water-resistant covering, such that the key charging components are “sealed” into the board before it is sold. There is also a controller that regulates flow of electrical current from the battery to the LED light ropes or light strips. This controller can be manually operated on the bodyboard itself, or remote controlled through the use of RF frequencies. One or more solar panels embedded in the deck of the bodyboard, optionally, provide recharging power for the battery.

The general concept behind this invention is that it can be used with a variety of bodyboard sizes and shapes. While the average “adult” bodyboard—usually between 3′ and 4′ in length—is used for purposes of illustration in this application, it is also contemplated that the same technology could be used for smaller bodyboards that could be created for children.

### HISTORY OF THE INVENTION'S INDUSTRY

Surfing and bodyboards have been known in the prior art for many decades. Surfboards can be decorated in a variety of ways, including airbrushing the foam blank and using different colors of resins. Bodyboards, on the other hand, are generally made from a molded piece of foam covered “skins” that cover the top, bottom, and sides. These skins can be of different colors, and have designs imprinted on them. One embodiment has fiberclad covers with, optionally, characters on the covers. As opposed to surfboards, which are generally rigid foam covered by epoxy resin or fiberglass impregnated with resin, bodyboards are made from a flexible foam core that bends when the bodyboard is subjected to the forces of an ocean wave.

There is prior art on the idea of putting lights on recreational boards. For example, US Publication No. 2014/0063828 to Roach teaches a skirt with LED's that can be attached to a stand-up paddle board. The current invention provides significant advantages over Roach, in that a skirt would not survive being pummeled by ocean surf. Also, the stand-up paddle board is a generally rigid board, like a surfboard, and molding or routing a channel into its side would not be economically feasible (hence, the use by Roach of a skirt).

Another relevant item of prior art is US Publication No. 2015/0217675 to Dayan. Dayan shows what appears to be a snow toy, complete with handles so the user can hang on. In the ocean, handles such as these would be ripped off quickly by the surf, and, indeed, could pose a problem to the user if he/she became entangled in a handle. Dayan also relies on a “light transmissive” foam with a lighting circuit embedded therein. The current invention does not require “light transmissive” foam, as the channel and the clear cover allow the light rope to transmit no matter what the opacity of the foam.

Dayan also discusses LED's that are partially embedded in the “core” and partially embedded in the shell. The current invention does not require any modification of “the shell” as the channel is covered by a removable cover. Dayan also teaches cutting the core with a knife to create the channel in which the LED sits. The current invention calls for the light channel to be molded into the foam core during its manufacturing process, so there is no need to a) endanger anyone who is using a (presumably) sharp knife to try to cut channels, and b) endanger the structural integrity of the board by cutting into it.

Dayan makes casual reference to the possibility of a solar panel, but not describe where it could be located or how it would function. The current invention limits any solar panel to being embedded in the deck (top side) of the bodyboard and to be flexible such that it does not break when the bodyboard is bent during use.

Thus, the invention is hereby presented. The invention is directed toward a bodyboard, used for use in aquatic environments, with one or more strings of LED light ropes disposed in one or more channels that have been molded into the top, bottom, and/or sides of the bodyboard during the manufacturing process of creating the core. The channels are covered with a water-resistant covering that protects the electrical components of the invention. The bodyboard also includes a cavity into which a battery is placed, where the battery powers the LED's, and means of controlling the LED's. The battery cavity is also covered by a water-resistant covering. There is, optionally, a flexible solar panel embedded into the deck of the bodyboard, that flexes as the bodyboard flexes during movement of the body board.

### OBJECTS OF THE INVENTION

It is therefore an object of the present invention to provide an enjoyable toy or a premium bodyboard for a youngster, amateur wave rider, performance artist, or any other person who would enjoy the invention who desires a bodyboard with colored, programmable LED light ropes creating a decoration on the bodyboard, where the bodyboard could be used in any aquatic environment.

Other objects of the invention include

a) allowing a manufacturer to customize the bodyboard to create a variety of colors and flashing patters with the LED light ropes during the manufacturing process,

b) an enjoyable toy to a youngster who desires a bodyboard with colored LED lights creating a decoration on the bodyboard, where the bodyboard could be used in any aquatic environment, where the colored LED's are powered by a rechargeable battery powered inductively through an outside electrical transmitter.

c) providing a waterproof, permanent, transparent or translucent covering over the channels in an alternative embodiment of the idea, and as an additional embodiment, containing an optional solar-powered, waterproof battery that is contained in a non-removable compartment, such that it remains charged from the solar cells attached to it, where the solar cells are flexible, and embedded into the deck of the bodyboard, and,

d) providing a bodyboard that is manufactured with a wireless charging system embedded into a cavity in the body board during its manufacturing process, such the watertight seal prevents water from damaging the battery and the other electrical components.

In generally, the bodyboard is used for enjoying aquatic environments, and has one of more strings of LED lights disposed in one or more channels that have been molded or routed into the top, bottom, or sides of the body board. The LED's are powered by a rechargeable battery pack disposed in a wireless charger cavity in the bodyboard, along with a wireless charging receiver and an LED controller, which is covered by a watertight bodyboard sealant cover to prevent water from damaging the electronic components. In particularly preferred embodiments, the bodyboard core is white beaded polypropylene foam and a P9242-R 15W wireless charging transmitter is used to charge a P9221-R 15W wireless charging receiver, or similar inductive charging parts.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects, and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a bodyboard with and embedded LED rope according to a preferred form of the invention.

FIG. 2 is a close-up view of the “channel” into which the LED light rope is placed.

FIG. 3 is a bottom view of a bodyboard with an embedded LED light rope according to a preferred form of the invention.

FIG. 4 is a top view of a bodyboard with an embedded LED rope according to a preferred form of the invention.

FIGS. 5 through 7 are cross sectional views of the channel in which the LED rope is placed.

FIG. 8 is a bottom view of a bodyboard showing the location of the cross-sectional view shown in FIG. 9.

FIG. 9 is a cross-sectional view.

FIG. 10 is a close-up view of one rail of the bodyboard.

FIG. 11 is a perspective view of a wireless charging system, which is another embodiment of the invention.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

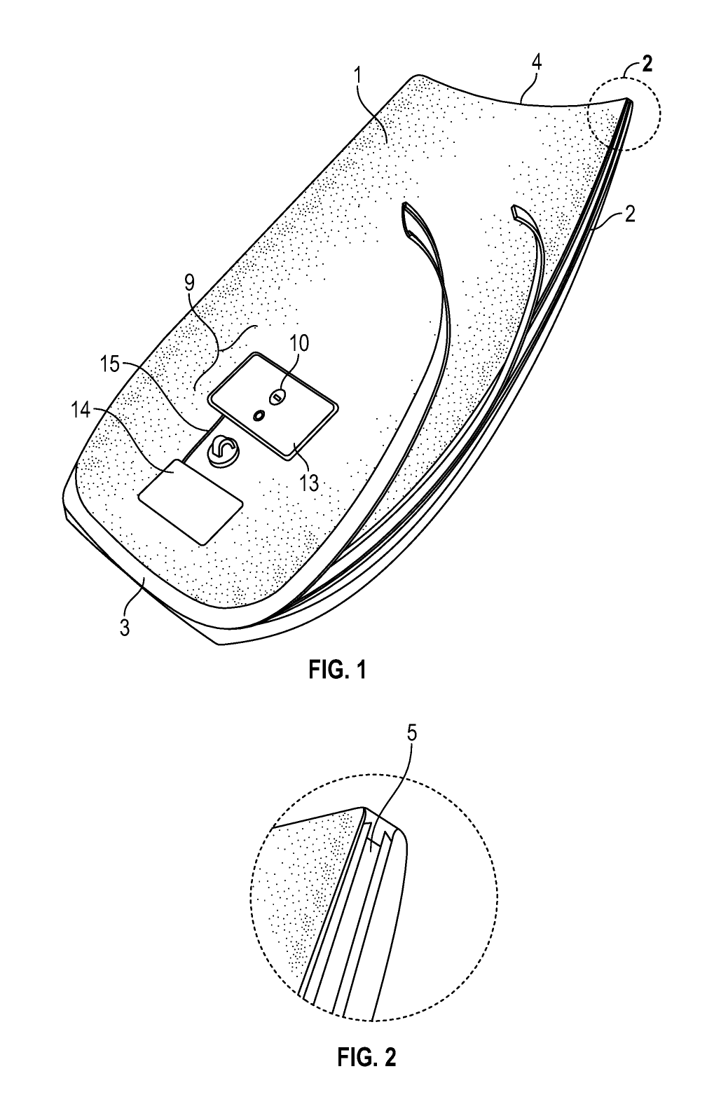

FIG. 1 is a perspective view of a bodyboard with embedded LED lights according to a preferred form of the invention. The bodyboard has a deck 1, rails 2, a bow 3 and a stern 4. On the deck 1 there is a battery compartment 9, into which the battery is removably secured. The battery compartment is waterproof due to a battery compartment cover 13, that can be removed through an access screw 10. A flexible solar panel 14 is embedded into the deck of the bodyboard, and connected to the battery by solar panel wiring 15. The battery can be turned on and off through a waterproof control button 11 and can be charged through a waterproof charging port, or through the solar charging system. From the battery, one or more LED light ropes are dispensed in channels routed into the deck, rails and/or bottom of the bodyboard. To use the invention, the user inserts LED light ropes into the channels, secures a waterproof cover, turns on the LED light ropes by pushing the waterproof control button, and goes bodyboarding.

FIG. 2 is a close-up view of the “channel” 5 into which the LED light rope is placed according to a preferred form of the invention.

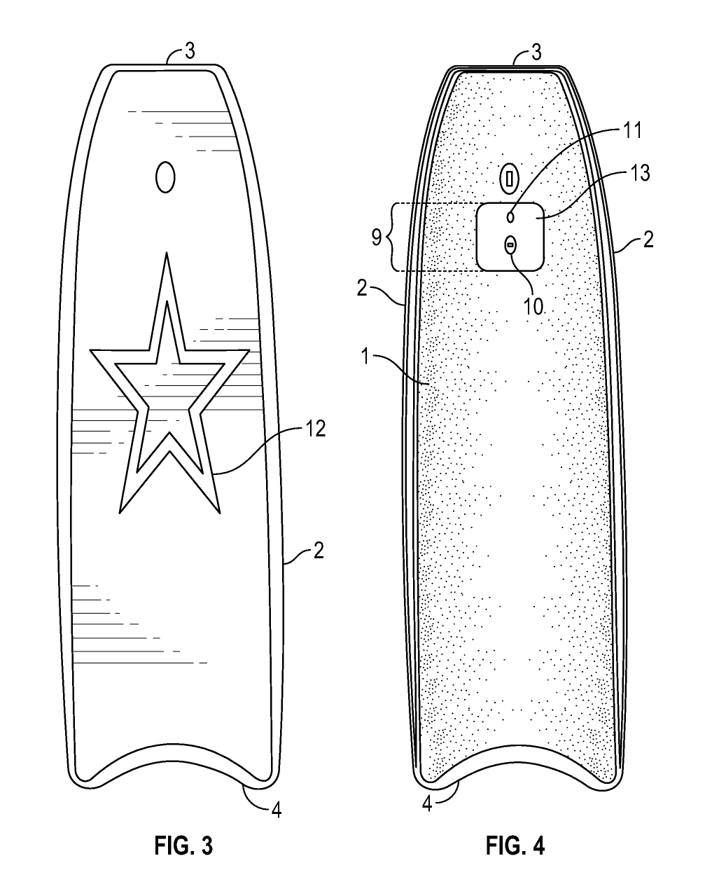

FIG. 3 is a bottom view of a bodyboard with embedded LED rope according to a preferred form of the invention. In the particular embodiment, a decorative pattern 12 is created in the shape of a star. It should be noted that the LED light ropes can be placed anywhere on the board, including the bottom, as shown here, the deck, the rails 2, and even the bow 3 and stern 4.

FIG. 4 is a top view of a bodyboard with embedded LED rope according to a preferred form of the invention. The battery compartment 9 is a cavity that has been molded or routed into the deck, in this case, of the bodyboard. Inside the battery compartment is a battery (not shown in this figure), which is covered by a waterproof battery compartment cover 13. There are several possible embodiments of the battery. First, it could be a water-resistant battery enclosed in a removable, water-resistant cover such that the battery could be removed for recharging. Second, the battery could be permanently encased by a non-removable cover where the battery is electrically attached to one or more solar panels attached to the top, side, or bottom of the board, or even resting on or embedded in the cover itself. The battery and the LED light ropes are controlled through a waterproof control button 11 which can be pushed to turn the LED light ropes on and off. In another embodiment of the invention, the waterproof control button 11 has several different settings that cause different light patterns to illuminate in the LED light ropes. The battery compartment cover 13 forms a waterproof seal over the battery compartment 9, and can be accessed through an access screw 10. Thus, before the user enters the water he/she can turn on the LED light ropes, then enjoy a water session, before returning to dry land and removing the battery for charging. In another embodiment, a waterproof charging station is included in the battery compartment cover 13 so that that user can charge the battery while the battery is still in the battery compartment. Again, it is contemplated that while a preferred embodiment of the invention calls for the LED light ropes to form a decorative pattern on the bottom of the bodyboard, as in FIG. 3, it is also contemplated that LED light ropes could be places on the rails 2, deck 1, or even the bow 3 and stern 4. It is further contemplated that LED light ropes, including strong ones, could be mounted on the bow 3 of the bodyboard to enhance the user's ability to see during low light and night time conditions.

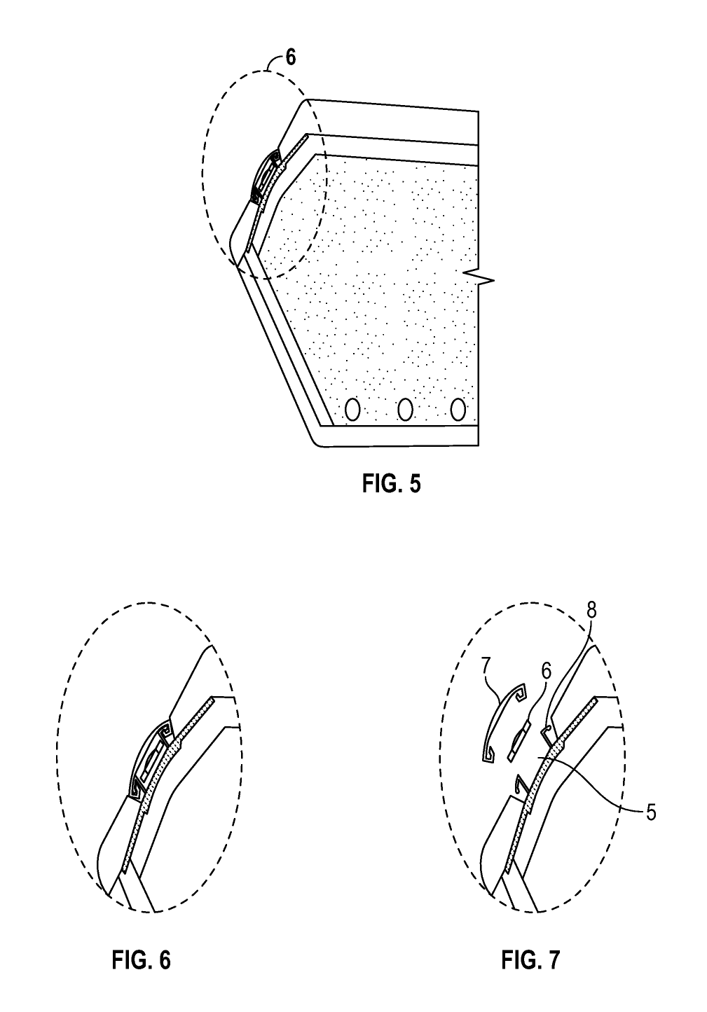

FIGS. 5 through 7 are cross sectional views of the channel in which the LED lights are placed. An LED light rope 6 is placed in a channel 5. A waterproof cover 7, is secured with grippers 8, such that water does not flood the channel 5. If the user wishes to change the colors, or flashing pattern of the LED's, he/she need only to remove the waterproof cover 7, and replace the LED light rope 6 with another one. In another embodiment, there are more than one color of lights in the channel, or the lights are capable of changing color, in which case it is not necessary to remove them from the channel, but rather a user can change the colors by merely pushing a control button or using a remote controller.

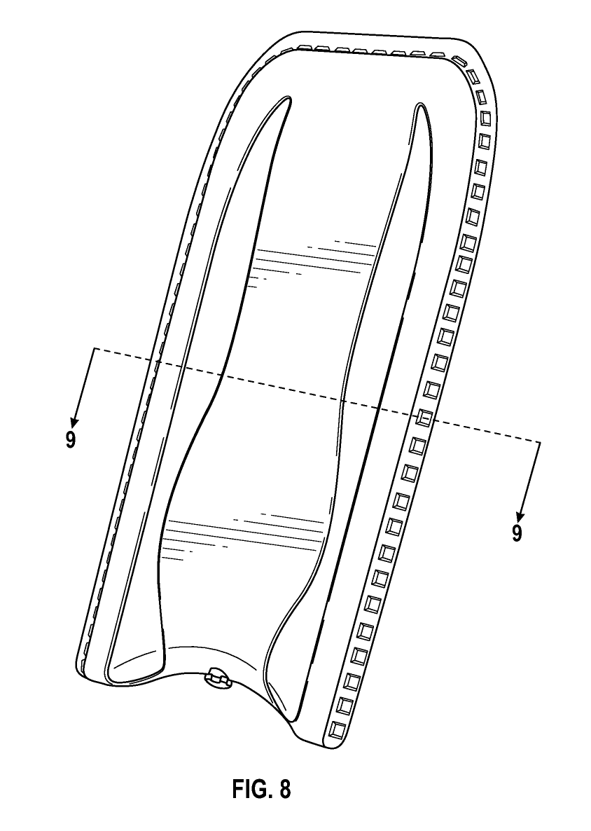

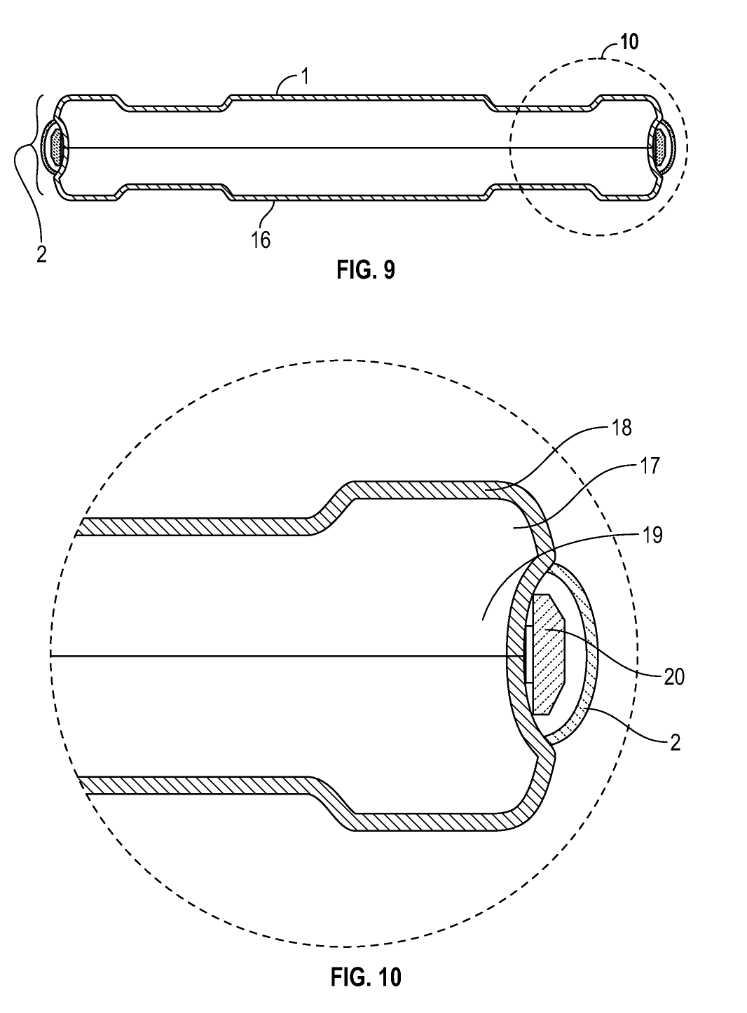

FIG. 8 is a bottom view of a bodyboard showing the location of the cross-sectional view shown in FIG. 9.

FIG. 9 is a cross-sectional view showing how the core 17 is covered by a skin 18 on both the deck 1 and the bottom 16 of the bodyboard. Item 10 shows where the close-up view of FIG. 10 originates.

FIG. 10 is a close-up view of one rail of the bodyboard. The foam core 17 is covered by a skin 18. The foam core has a molded channel 19 that is covered by the skin 18. Inside the molded channel 19 is an LED light rope 20, which is covered by a removable cover 2. Because the molded channel 19 is molded into the foam core 17, the structural integrity of the bodyboard is not compromised as if the channel was cut with a knife or routed into an existing foam core. The LED light rope 20 is a substantial improvement over the strings of LED's used previously. Most LED light ropes are sealed inside a clear, waterproof cylinder, such that the removable cover 20 provides a second layer of waterproof protection. The prior art shows use of LED light “strings” which are series of LED's connected by wiring, where there is a potential “short” at every connection. Removable cover 20 can be attached by grippers or a detachable adhesive.

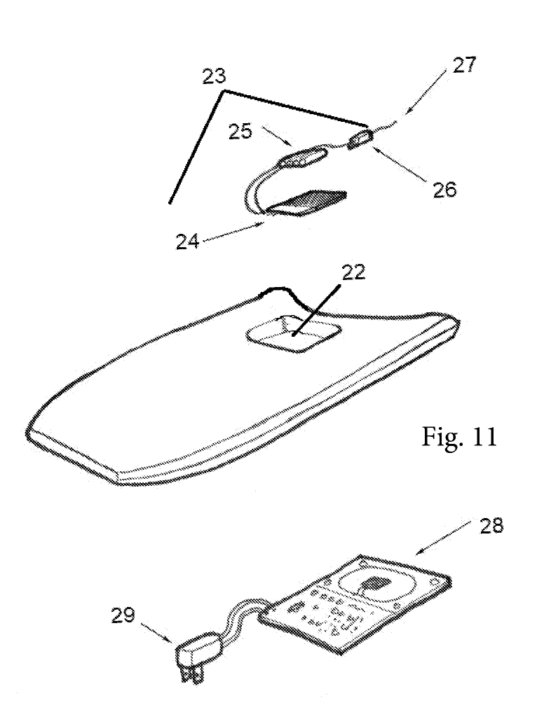

FIG. 11 is a perspective view of a wireless charging system, which is another embodiment of the invention. The body board 1 has a wireless charging cavity 22, into which a wireless charger, generally 23 is inserted prior to the body board being sealed. The wireless charger has a wireless charging receiver 24, which receives electrical energy from a wireless charging transmitter 28, which is powered from a wall charger 29. The wireless charging receiver 24 recharges a rechargeable battery pack 25, which lights the LED strips through an LED controller 26, from which a wire to LED strip 27 extends. Through this mechanism, a user can simply recharge the battery that is sealed within the watertight body board by merely placing the wireless charging transmitter over the wireless charging receiver.

In a particularly preferred embodiment, a P9242-R 15W wireless charging transmitter is used to charge a P9221-R 15W wireless charging receiver. These particular wireless chargers and wireless receivers were specifically selected based on their light weight and ability to rapidly charge a rechargeable battery. This allows for a user of the invention to quickly recharge the batteries and get back out in the water more quickly.

In another particularly preferred embodiment, the body board is made from white beaded polypropylene foam. This material is significantly more rigid than standard polyethylene foam and will dampen the bending of the board, which can be detrimental to the LED strips. The denser foam will also reflect more light back into the channel, as there will be less light “spilled into” the foam, as is the case with less dense foam.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### REFERENCE NUMBERS USED

1. Bodyboard deck
2. Bodyboard rails
3. Bodyboard bow
4. Bodyboard stern
5. Channel
6. LED light rope
7. Cover
8. Grippers
9. Battery compartment.
10. Access screw.
11. Waterproof control button
12. Decorative pattern.
13. Waterproof battery compartment cover.
14. Solar panel
15. Solar panel wiring
16. Bodyboard bottom
17. Bodyboard core
18. Bodyboard skin
19. Molded channel
20. LED light rope
21. Removable cover
22. Wireless charging cavity
23. Wireless charger, generally
24. Wireless charging receiver
25. Battery pack
26. LED Controller
27. Wire to LED strip
28. Wireless charging transmitter
29. Wall charger.

That which is claimed is:

1. A bodyboard for use in aquatic environments with LED light decorations, comprising: a bodyboard, where the bodyboard has a bodyboard sealant cover, a deck, a bottom, a bow, a stern, and two rails, where the two rails comprise a port rail and a starboard rail, where the bodyboard has a length, where the bodyboard has a height and at least one channel, where the at least one channel is molded by a molding process, where the molding process created the at least one channel into the bodyboard, at least one LED light rope comprising LED lights, where the at least one channel comprises a cavity with a cavity width, a cavity length, and a cavity depth, where the at least one LED light rope is disposed in the at least one channel, and covered by the bodyboard sealant cover, a battery compartment, a Wireless charging receiver, a rechargeable battery, an LED controller and a wire to LED strip, and the wireless charging receiver, the rechargeable battery, the LED controller and the wire to LED strip are all disposed in the battery compartment, and where the at least one LED light rope is electronically attached to the battery, and covered by the bodyboard sealant cover, where by bodyboard sealant cover is watertight, and where the bodyboard sealant cover extends over the deck, the bottom, the bow, the stern, and the two rails of the bodyboard.

2. The bodyboard of claim 1, additionally comprising a wireless charging transmitter, where the wireless charging transmitter can charge the wireless charging receiver housed within the bodyboard.

3. The bodyboard of claim 2, where the wireless charging transmitter additionally comprises a wall charger, such that the wireless charging transmitter can be plugged into an electrical outlet.

4. The bodyboard of claim 3, where the wireless charger is a P9242-R 15W wireless charging transmitter.

5. The bodyboard of claim 3, where the wireless receiver is a P9221-R 15W wireless charging receiver.

6. The bodyboard of claim 1, where the bodyboard additionally comprises one or more solar panels, where the one or more solar panels are flexible solar panels, where the one or more solar panels are embedded into the deck of the bodyboard, and the one or more solar panels provides an amount of recharging energy to the battery whenever the bodyboard is left in a sunny location.

7. The bodyboard of claim 1, where the bodyboard has a core, and the core is white, beaded polypropylene foam.

8. The bodyboard of claim 7, where the wireless charger is a P9242-R 15W wireless charging transmitter, and where the wireless receiver is a P9221-R 15W wireless charging receiver.

9. The bodyboard of claim 8, where the bodyboard has a flexible core, where the height of the bodyboard is less than two inches, where the LED light rope serves a decorative purpose only, and where the bodyboard does not have any handles or straps.

10. A bodyboard for use in aquatic environments with LED light decorations, comprising: a bodyboard, where the bodyboard has a bodyboard sealant cover, a deck, a bottom, a bow, a stern, and two rails, where the two rails comprise a port rail and a starboard rail, where the bodyboard has at least one channel, where the at least one channel is molded by a molding process, where the molding process created the at least one channel into the bodyboard, at least one LED light rope comprising LED lights, where the at least one LED light rope is disposed in the at least one channel, and covered by the bodyboard sealant cover, a battery compartment, a Wireless charging receiver, a rechargeable battery, an LED controller and a wire to LED strip, and the wireless charging receiver, the rechargeable battery, the LED controller and the wire to LED strip are all disposed in the battery compartment, and where the at least one LED light rope is electronically attached to the battery, and covered by the bodyboard sealant cover, where by bodyboard sealant cover is watertight.

11. The bodyboard of claim 10, where the bodyboard sealant cover extends over the deck, the bottom, the bow, the stern, and the two rails of the bodyboard.

12. The bodyboard of claim 11, additionally comprising a wireless charging transmitter, where the wireless charging transmitter can charge the wireless charging receiver housed within the bodyboard.

13. The bodyboard of claim 12, where the wireless charging transmitter additionally comprises a wall charger, such that the wireless charging transmitter can be plugged into an electrical outlet.

14. The bodyboard of claim 13, where the wireless charger is a P9242-R 15W wireless charging transmitter.

15. The bodyboard of claim 13, where the wireless receiver is a P9221-R 15W wireless charging receiver.

16. The bodyboard of claim 10, where the bodyboard additionally comprises one or more solar panels, where the one or more solar panels are flexible solar panels, where the one or more solar panels are embedded into the deck of the bodyboard, and the one or more solar panels provides an amount of recharging energy to the battery whenever the bodyboard is left in a sunny location.

17. The bodyboard of claim 10, where the bodyboard has a core, and the core is white, beaded polypropylene foam.

18. The bodyboard of claim 17, where the wireless charger is a P9242-R 15W wireless charging transmitter, and where the wireless receiver is a P9221-R 15W wireless charging receiver.

19. The bodyboard of claim 18, where the bodyboard has a flexible core, where the height of the bodyboard is less than two inches, where the LED light rope serves a decorative purpose only, and where the bodyboard does not have any handles or straps.

20. The bodyboard of claim 19, where the at least one channel comprises a cavity with a cavity width, a cavity length, and a cavity depth, where the bodyboard has a length, where the bodyboard has a height, where the bodyboard does not have any handles or straps and where the height of the bodyboard is less than two inches.
